(19) United States
(12) Patent Application Publication
(10) Pub. No.: US 2022/0036493 A1
(43) Pub. Date: Feb. 3, 2022

(54) Beacon-Based Truck Supply Chain Coordinating System

(71) Applicant: Command Alkon Incorporated, Birmingham, AL (US)

(72) Inventor: Rob Piosik, Heerlen (NL)

(21) Appl. No.: 17/384,852

(22) Filed: Jul. 26, 2021

Related U.S. Application Data
(60) Provisional application No. 63/058,781, filed on Jul. 30, 2020.

(51) Int. Cl. G06Q 50/28; H04W 4/44; G07C 11/00; G07C 5/00; G06Q 10/06; G06Q 10/00; G01S 1/68

(52) U.S. Cl. CPC G06Q 50/28; H04W 4/44; G07C 11/00; G07C 2011/04; G06Q 10/06312; G06Q 10/20; G01S 1/68; G07C 5/008

(57) ABSTRACT

There is provided a method of coordinating the actions of a plurality of trucks using at least one beacon sending a first signal including a first signal beacon identifier to a first truck device of a first one of the trucks, the at least one beacon sending a second signal including a second signal beacon identifier to a second truck device of a second one of the trucks, a coordinating computer receiving a first input from the first truck device, the first input including at least the first signal beacon identifier and a first truck identifier, receiving a second input from the second truck device, the second input including at least the second signal beacon identifier and a second truck identifier, determining a queue order for the trucks based on the first input and the second input, and transmitting directive signals to the trucks based on the queue order.

### CROSS-REFERENCE TO RELATED APPLICATIONS

This application claims the benefit of U.S. provisional application No. 63/058,781, filed 27 Jul. 2021, which is hereby incorporated by reference as though fully set forth herein.

### FIELD

The improvements generally relate to the field of industrial vehicle management.

### BACKGROUND

Industrial truck fleet operators in the heavy building materials industry spend non negligible amounts of time verifying, instructing and organizing their fleet in order to optimize their truck use. In many cases, industrial fleet operators still use wireless voice communication methods, whether it be through radio channels, cellular network services or other interfaces, to determine key truck information, such as determining what the truck is doing, where the truck is located, if they are pending the completion of another truck's task and what the most efficient next step is, if any. This method of communication quickly becomes cumbersome with an increasingly large fleet, making it time consuming, difficult to manage and costly, while further depending on the information that is being provided to the operator by the driver of the truck, which can be delayed, inaccurate or simply inopportune. Optimization may further be complicated by unpredictable fleet schedule changes due to client demand, technical complications, truck malfunction, etc.

In recent years, several efforts have been made to increasingly automate the coordination process. However, while known techniques were satisfactory to a certain degree, there always remains room for improvement.

### SUMMARY

Industrial fleet management can require numerous operators, complex planning and extensive logging when attempting to optimize production and logistics in industrial environments, such as concrete batch plants or aggregate quarries for instance. In these locations, operators give great importance to tracking the truck's position, understanding what the truck status is and determining what the most efficient subsequent task should be. Truck drivers are required to report their status, position and any other condition (such as returning with reusable load, for instance) to the operator and, in certain circumstances, await instructions. Using communication protocols, such as voice call-in's to the operators when arriving at a plant or quarry for instance, or using a status reporting apparatus, such as a status box, were considered as avenues permitting to streamline the management of the fleet, but there remained challenges to be addressed. Notably in the truck reporting and task assignment efficiency, the operator decision making efficiency, the fleet task assignment optimization and the fleet event and status logging.

It was found that such challenges can be addressed by providing a truck coordination system, including beacons configured to send a signal, truck devices containing a truck computer configured to receive the beacon signal, and a coordinating computer configured to communicate with the truck devices. It was found that such a system is capable of efficiently reporting truck condition and status information, while further receiving up-to-date and optimized instructions. The strain placed on both the operators and the truck drivers may be alleviated by at least partially removing the responsibility for each party to report to the other. It was further found that a coordinating computer, such as found in the truck coordination system, may be further capable of storing a set of rules such as to be configured to transmit directive signals to the trucks based on the inputs communicated from the truck devices. This permits rapid and efficient optimization of truck task assignment, including the capacity to overcome unexpected circumstances by prioritizing certain truck conditions, for instance.

In accordance with one aspect, there is provided a computer-implemented method of coordinating the actions of a plurality of trucks using at least one beacon, the method comprising the at least one beacon sending a first signal including a first signal beacon identifier to a first truck device of a first one of the trucks, the at least one beacon sending a second signal including a second signal beacon identifier to a second truck device of a second one of the trucks, a coordinating computer receiving a first input from the first truck device, the first input including at least the first signal beacon identifier and a first truck identifier, the coordinating computer receiving a second input from the second truck device, the second input including at least the second signal beacon identifier and a second truck identifier, the coordinating computer determining a queue order for the trucks based on the first input and the second input, and the coordinating computer transmitting directive signals to the trucks based on the queue order.

In accordance with another aspect, there is provided a computer program product comprising a computer readable memory storing computer executable instructions thereon that, when executed by a computer, coordinates the actions of trucks by receiving a first input from a first truck device, the first input including at least a first signal beacon identifier and a first truck identifier, receiving a second input from a second truck device, the second input including at least a second signal beacon identifier and a second truck identifier, determining a queue order for the trucks based on the first input and the second input, and transmitting directive signals to the trucks based on the queue order.

It will be understood that the expression “computer” as used herein is not to be interpreted in a limiting manner. It is rather used in a broad sense to generally refer, as schematized in FIG. 5, to the combination of some form of one or more processing units 10 and some form of memory system 12 accessible by the processing unit(s). The memory system 12 can be of the non-transitory type. The use of the expression “computer” in its singular form as used herein includes within its scope the combination of a two or more computers 14 working collaboratively to perform a given function. Moreover, the expression “computer” as used herein includes within its scope the use of partial capabilities of a given processing unit.

A processing unit 10 can be embodied in the form of a general-purpose micro-processor or microcontroller, a digital signal processing (DSP) processor, an integrated circuit, a field programmable gate array (FPGA), a reconfigurable processor, a programmable read-only memory (PROM), to name a few examples.

The memory system 12 can include a suitable combination of any suitable type of computer-readable memory located either internally, externally, and accessible by the processor in a wired or wireless manner, either directly or over a network such as the Internet. A computer-readable memory can be embodied in the form of random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) to name a few examples.

A computer 14 can have one or more input/output (I/O) interface 16 to allow communication with a human user and/or with another computer 14 via an associated input, output, or input/output device such as a keyboard, a mouse, a touchscreen, an antenna, a port, etc. Each I/O interface 16 can enable the computer to communicate and/or exchange data with other components, to access and connect to network resources, to serve applications, and/or perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, Bluetooth, WiMAX), SS7 signaling network, fixed line, local area network, wide area network, to name a few examples.

It will be understood that a computer can perform functions or processes via hardware or a combination of both hardware and software. For example, hardware can include logic gates included as part of a silicon chip of a processor. Software (e.g. application, process) can be in the form of data such as computer-readable instructions 18 stored in a non-transitory computer-readable memory accessible by one or more processing units 10. With respect to a computer or a processing unit, the expression “configured to” relates to the presence of hardware or a combination of hardware and software which is operable to perform the associated functions.

Many further features and combinations thereof concerning the present improvements will appear to those skilled in the art following a reading of the instant disclosure.

### DESCRIPTION OF THE FIGURES

In the figures,

FIG. 1 is a top view of a batch plant side having a truck coordinating system implemented;

FIG. 2 is a view of an example of a truck coordinating system;

FIG. 3 is a schematic view of an example of a beacon, as used in the truck coordinating system of FIG. 2;

FIG. 4 is a block diagram of an example of a truck coordinating computer communication scheme;

FIG. 5 is a schematic view of an example computer which can be used as one or more of a truck computer, an interface computer, a coordinating computer, an API computer, a database computer and/or a beacon control computer;

FIG. 6A is an example embodiment of concrete trucks equipped with the truck device of FIG. 2 at different distances from a loading station with a beacon;

FIG. 6B is an example reported data from the trucks of FIG. 3A;

FIG. 7 is another example embodiment of a concrete truck equipped with a truck device receiving signals from two different beacons;

FIG. 8 is an example of a coordinating computer coordinating a queue and determining truck directives of a plurality of trucks;

FIG. 9 is another example of a coordinating computer coordinating a loading station queue and determining truck directives based on truck status and distance from a station;

FIG. 10 is yet another example of a coordinating computer coordinating slump stand queues and determining truck directives based on truck status and distance from two slump stands;

FIG. 11 is yet another example of a coordinating computer coordinating a loading station queue and determining truck directives based on truck status, distance from the loading station and fill status;

FIG. 12 is yet another example of a coordination computer coordinating a reclaimer station queue and determining truck directives based on truck status, distance from the reclaimer station, fill station, cleaning status and maintenance status.

FIGS. 13A to 13C is an example of a coordinating computer coordinating a loading station queue, where the progression of the directives and the queue can be seen;

FIGS. 13D to 13E is an example of a coordinating computer coordinating a loading station queue, where progression of the directives can be seen when a first truck in the queue does not correspond to a truck with a “loading” truck status;

FIG. 14A shows a flow chart of an example method of confirming that the correct truck is undergoing a activity based on a beacon signal; and

FIG. 14B shows a flow chart of another example method of confirming that the correct truck is undergoing a activity based on a beacon signal.

### DETAILED DESCRIPTION

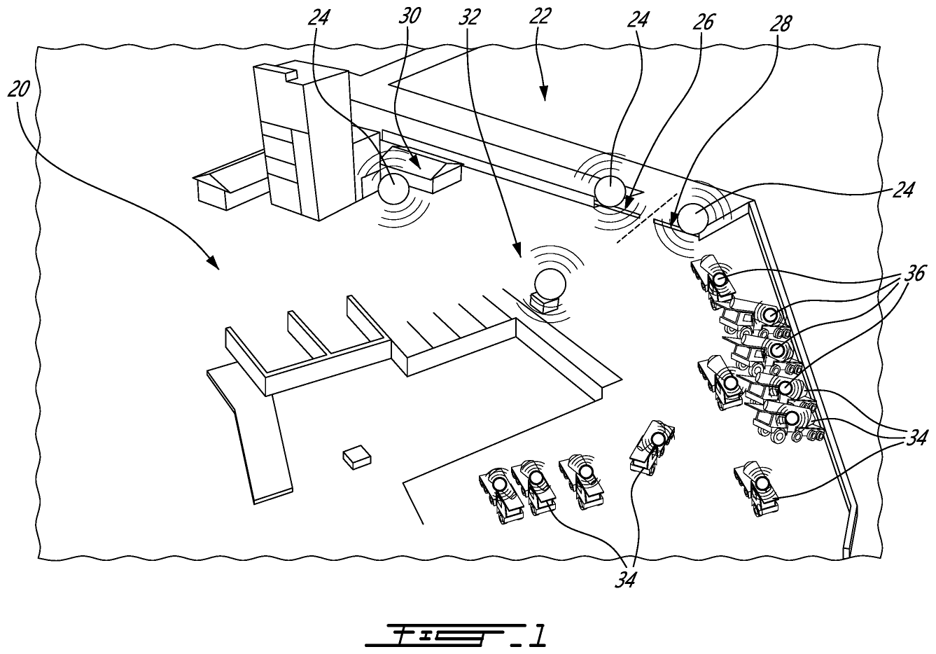

FIG. 1 show an example batch plant 20 site having a truck coordinating system 22 implemented. In this batch plant site 20, key locations contain beacons 24, such as for instance at the arrival gate 26, the departure gate 28, the loading station 30 and the slumping station 32.

The trucks 34 dispersed on the batch plant 20 may be equipped with a truck device 36 capable of wireless communication, such as internet access for instance. The trucks 34 equipped with the truck devices 36 may receive signals from the beacons 24 in their vicinity and report the received signal to a coordinating computer (not shown in FIG. 1) as an input. Such a system permits efficient reporting of truck 34 condition and status. Said coordinating computer may further transmit instructions back to the truck device 36, such as to optimize and coordinate the truck tasks based on the input information received.

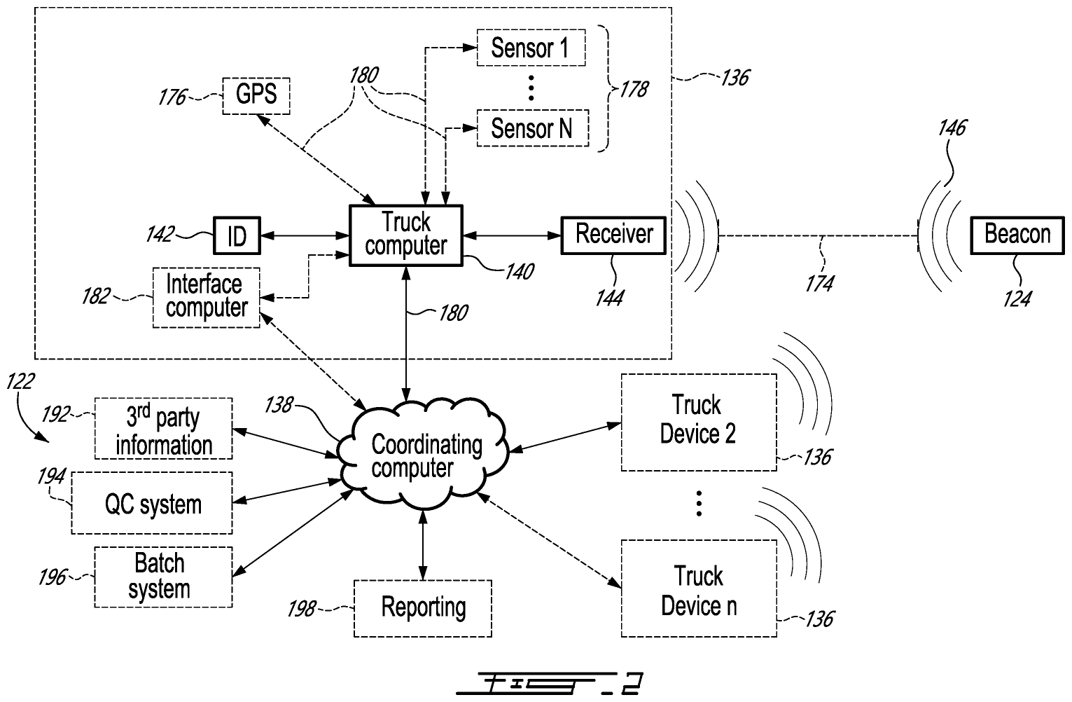

FIG. 2 shows an example of the truck coordination system 122, including a beacon 124, a truck device 136 and a coordination computer 138. In this embodiment, the truck device 136 may contain a truck computer 140. The truck computer 140 may contain a truck identifier 142 within its memory and/or be in communication with a memory containing a truck identifier 142, which may be used to refer to the truck (not shown) and/or truck device 136 associated to the truck. The identifier 142 may for instance be a computer serial number, an truck serial number or a common truck name, to name a few examples.

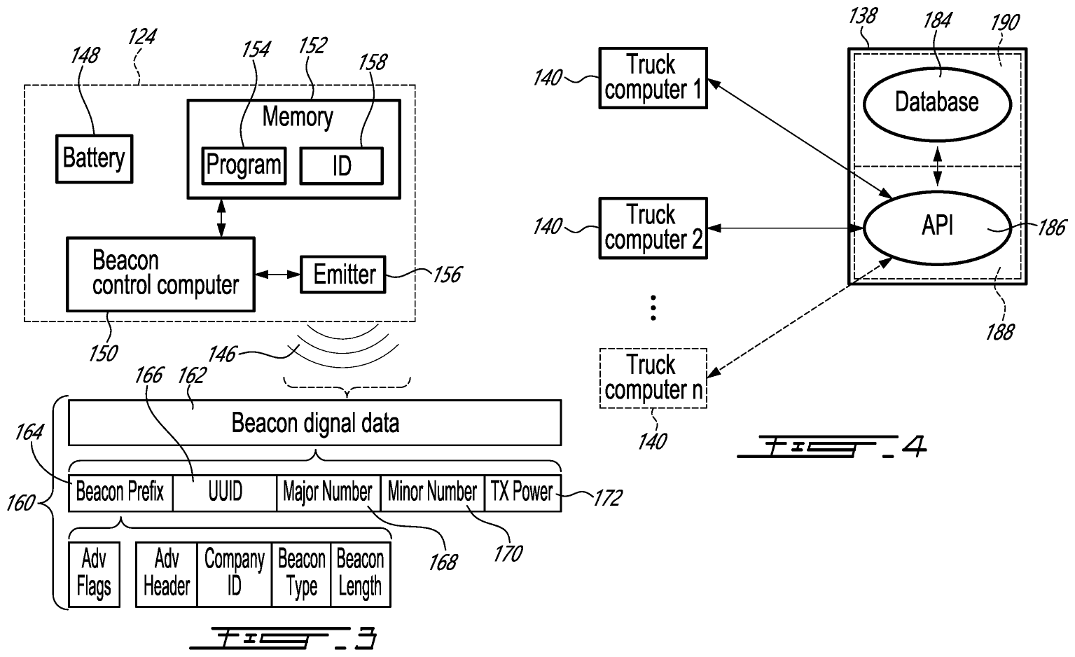

The truck computer 140 may further contain, or be in communication with, a receiver 144. The receiver 144 may be configure to wirelessly receive a signal 146 from a beacon 124. In this particular example the receiver 144 is a Bluetooth receiver configured to receive a Bluetooth signal from beacon, which is correspondingly a Bluetooth beacon. As perhaps best seen in FIG. 3, showing a schematic view of an example beacon 124, the beacon 124 may be powered by a battery 148, and controlled by a beacon control computer 150. The beacon 124 can contain a memory 152 with a program 154 configured to make the beacon 124 continously emit a signal 146 via an emitter 156. The beacon 124 may contain an beacon identifier 158, which can be emitted as part of the signal 146 and readable by a corresponding receiver 144 that may receive the emitted beacon signal 146.

It will be understood that the Bluetooth beacon 124, and thus a corresponding receiver 144, may be adapted or replaced by any other suitable beacon/receiver combination, which may use alternative signal types, such as 3G, 4G, LTE, Wi-Fi, etc. without departing from the present disclosure. Similarly, the beacon's program 154 or configuration may be altered without departing from the present disclosure. For instance, in an alternate embodiment, the beacon 124 may be connected to a power grid and receive power directly via wired methods instead of a battery. In yet another embodiment, the beacon 124 may be configured to transmit signals intermittently, at a preferred frequency, for instance.

Independently of its type, the beacon 124 will typically include, within the transmitted signal 146, an identifier 158 allowing it to be identified amongst other beacons, and its transmitted signal will typically comply with a pre-established form of communications protocol 160. The complexity of the identifier can depend on the amount of potential confusion from the various beacons. For instance, in a system having a single beacon, as long as a signal is detected, it can be determined to be from the beacon without even necessitating a beacon ID. If the system has two beacons, the beacon ID can be a 1 bit identifier, either 0 or 1, and that would be sufficient to distinguish one beacon from the other. In many practical cases, the actual identifier of the beacon can be significantly more complex.

In the specific case of a Bluetooth beacon for instance, the communications protocol can be the Bluetooth protocol. An example device which can be used is the FeasyBeacon FSC-BP108 bluetooth 5.1 low energy smart beacon for instance. In the case of the FeasyBeacon device, the transmitted signal 146 can be as indicated at the bottom of FIG. 3. The Beacon signal data 162 can be seen to include an Beacon Prefix 164, a UUID 166, a Major Number 168, a Minor Number 170, and a TX (transmit) Power 172. The UUID 166 is a Universally Unique Identifier, part of a standard identifying system which allows a ‘unique’ number to be generated for a device (or in the case of Beacons, manufacturer, application or owner). The purpose of the UUID can be to distinguish Beacons in a network, from all other beacons in the network, for instance. The structure of the Beacon prefix 164 can take numerous forms. In FIG. 3, one example is shown, which includes flags, a heater, a company ID, the beacon type and length.

Returning to FIG. 2, the receiver 144 of the truck device 136 can be seen wirelessly receiving a signal 146 from a beacon 124 placed at a certain distance 174 from the truck device 136. The receiver 144 can be configured to read the beacon identifier 158 from the beacon signal 146 and communicate the received information to the truck computer 140. As will be discussed below, while the receiver 144 is shown as receiving a signal from a single beacon 124, it will be understood that the receiver may receive a plurality of beacon signals from a plurality of beacons.

The truck computer 140 can further be configured to communicate with other systems. For instance, the truck computer 140 can have a global positioning system (GPS) 176 capable of receiving GPS satellite information, and may contain an interfacing computer 182 , in communication with the truck computer 140, for displaying information to the driver. The truck computer may further be adapted to interface with other sensors 178 within or external to the truck, and can form part of the truck device. Such sensors may, for instance, be a mixing drum load sensor, a mixing drum rotational speed sensor, a mixing drum directional sensor, a water tank level meter, a speedometer, etc. The sensors 178 may communicate with the truck computer 140 in whole or in part by a wire or by any other suitable means of communication 180, such as Bluetooth or RF signals for instance.

One will understand that the truck device 136 may be altered, such as by adding, removing or omitting the sensors 178 or additional interfacing computer(s) 182 for instance. It will further be understood that the communication means 180 between the different elements of the truck device may also be altered without departing from the present disclosure. Moreover, it will understood that the sensors 178 or additional systems may alternatively communicate with any of the truck device elements instead of the truck computer 140 directly. For instance, should the truck device 136 receiver 144 be a Bluetooth device and one of the sensors 178 have Bluetooth communication means, one may understand that one or more the sensors 178 may communicate the sensor data to the truck computer 140 via the receiver of the truck device 144. One further understands that the components and configurations of each truck device may be altered between trucks being managed by the truck coordinating system 122 without departing from the present disclosure.

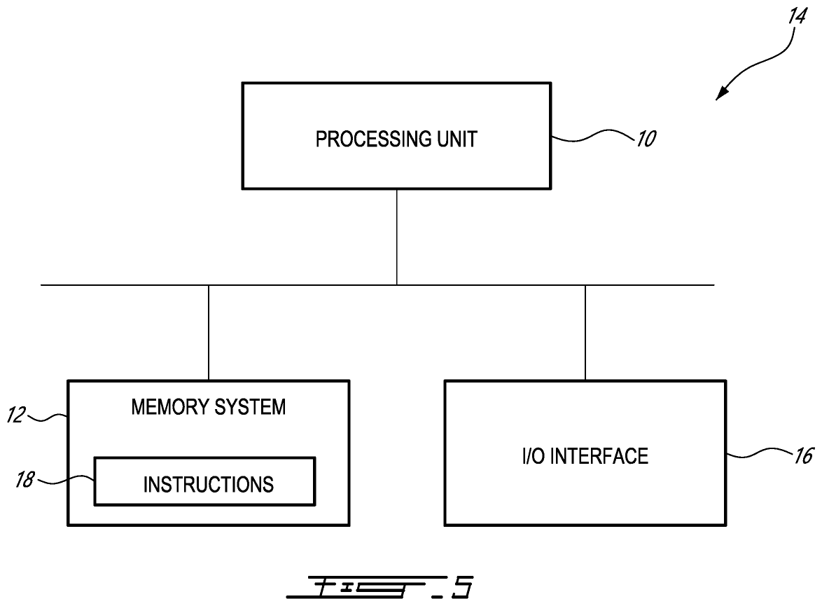

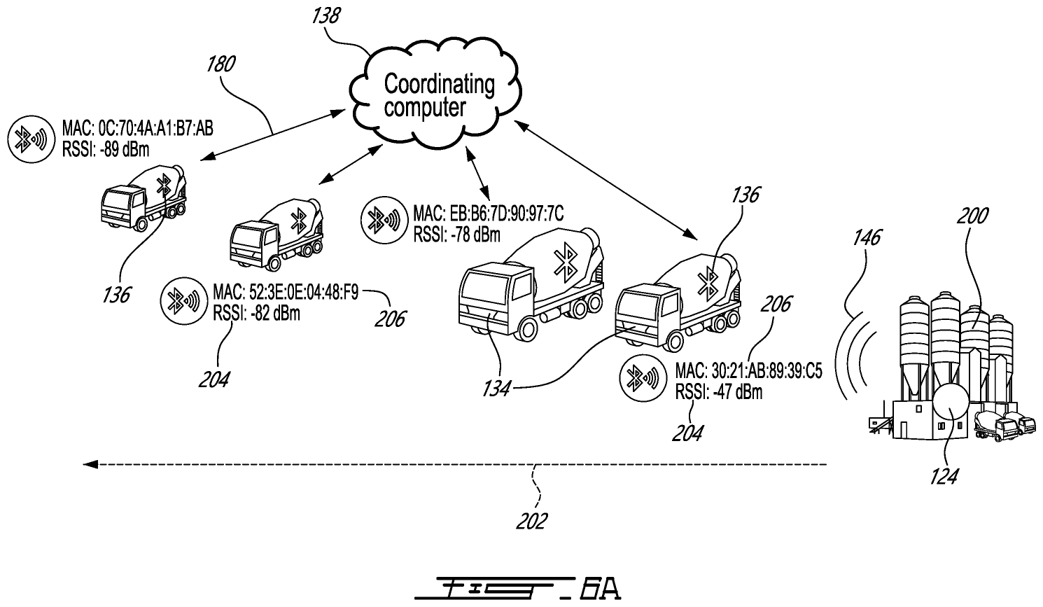

The truck computer 140 can be provided with a coordinating computer communication software such as to permit interfacing with a coordinating computer 138 configured to receive signals from the different truck devices 136. The inputs received from the truck devices may incorporate the truck identifier and the beacon identifier of a received beacon signal 146 by the truck devices 136, for instance. The coordinating computer 138 may be capable of processing the inputs from the different truck devices 136 and accessing a database 184 (FIG. 4), such as to create, read, update (modify) or delete information or entries based the input being provided.

Attention is now brought to FIG. 4 showing a block diagram of an example of a truck coordinating computer communication scheme. In this example, the inputs from different truck computers 140 can be received by a database interface software application 186 which will be referred to herein as an API. This API 186 runs on an API computer 188 forming part of the coordinating computer 138. Similarly, the database 184 also has a software which can run on a computer, and can be the same computer as the API computer 188, or a different computer, which can be referred to as the database computer 190. In this particular example, the API 186 and the database 184 run on the same computer, which will be generally referred to in this application as the coordinating computer 138. The API 186 can include a process of receiving the input from the truck devices 136, or in this particular example from the truck computers 140, and determine an operation to be taken on the database 184. The database 184 may receive the operation instructions and take the necessary actions to proceed with the recordal. The database 187 can contain a status table, comprising the status of different trucks for instance, and may further contain station queues, both of which will be discussed in further detail below. In this particular embodiment, the database 184, containing the status table and the station queues, can provide directive information in return to the API 186, which can be relayed back to the truck computer 140. Such directive information can contain instructions or a task to be performed by the truck driver, for instance.

In one example, the database can be the DynamoDB database from Amazon Web Services (AWS), for instance, or any other suitable database. It will be understood that the coordinating computer communication scheme above is for exemplary purposes only, and may be altered without departing from the present disclosure.

Returning to the truck coordination system of FIG. 2, the truck device 136 can communicate with the coordination computer 138 via any suitable communication means 180 such as via the internet through a long range communication network (ex. 3G, 4G, LTE, etc.), for instance. It will be understood that the communications means 180 may be altered without departing from the present disclosure. For instance, referring to the example batch plant site 20 of FIG. 1, the batch plant site 20 may be equipped with a local intranet communication system, where the communication means may be through a local Wi-Fi network.

Still referring to FIG. 2, the coordinating computer 138 may further be configured to communicate with external platforms such as to transmit information regarding the truck signals or receiving information from sources other than the truck device. In this particular example, the coordinating computer 138 may be receiving and transmitting information from a 3^{rd} party member 192, a quality control member 194, and/or a batch system member 196. The coordinating computer 138 may further be configured to report 198 the information it has collected from the different truck devices 136 and/or the external members 192, 194, 196 to an external database, such that an operator may be capable of reviewing key information received by the coordinating computer 138, for instance.

It will be understood that in alternate embodiments, the truck coordinating system 122 may comprise a plurality of coordinating computers 138, such as a coordinating computer for each one of the batch plant sites, for instance. In yet another alternate embodiment, the multiple coordinating computers may interface with a single common database.

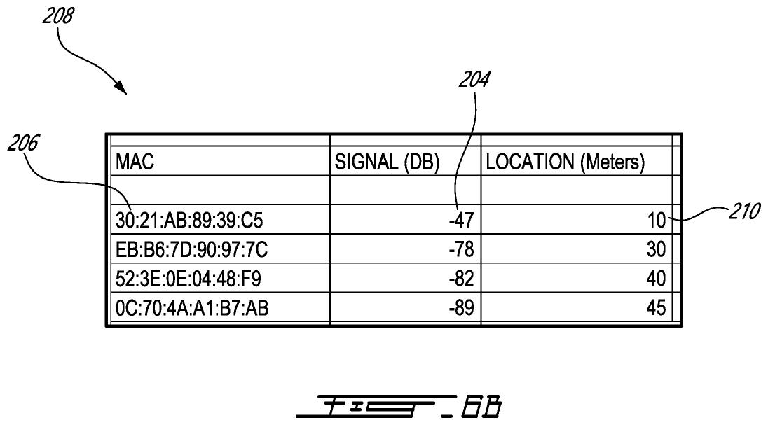

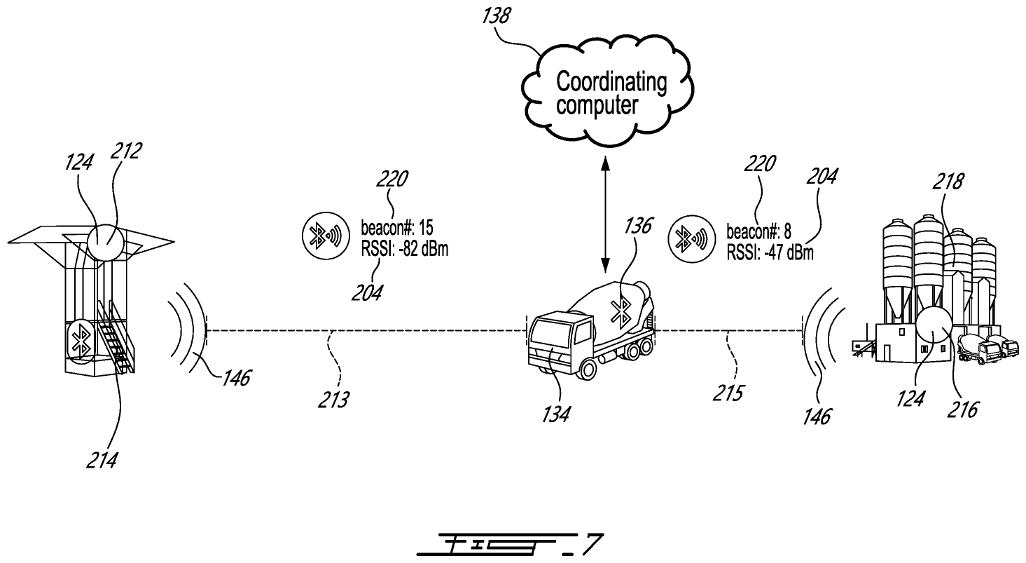

Attention is now brought to FIG. 6A, showing an example embodiment of trucks 134 in a batch plant site equipped with the truck device 236 of FIG. 2, incorporating a Bluetooth receiver 144. The trucks 134 may be at different distances from a loading station 200, which can be equipped with a Bluetooth beacon 124. As explained above, the beacon 124 emits a signal 146 which can be received by the truck device 136 on each truck 134. FIG. 6A shows an example in which the different trucks 134 may be placed at increasing distances from the beacon 124, and thus from the loading station 200, and in which all trucks 134 can receive the signal 146 emitted by the beacon 124. In this particular example, the trucks 134 can be seen placed one after the other from the loading station 200, where the increasing distance is shown by the distance 202 line. The receiver (not explicitly shown) of the truck devices 136 can record a received signal strength indicator (RSSI) value 204, indicative of the level of power received from the signal 146 emitted by the beacon 124. Following the receipt of the beacon signal 146, the trucks 134 may communicate with and send inputs to the coordinating computer 138, such as the RSSI value 204, a truck device identifier 206 (shown as a MAC address) and a beacon identifier (not shown).

In this particular example, the truck device 136 may be configured to transmit the RSSI value 204 of the beacon 124 to the coordinating computer 138 as a estimate of the distance 202 from the beacon 124. As will be exemplified below, the received signal strength indicator value 204 can be directly correlated to a distance 202 from a beacon 124, such as a value in meters, and may be logged and/or used by the coordinating computer 138 in the prioritization of tasks (discussed in further details below). FIG. 6B show an example of data that can be reported from the coordinating computer 138 having received inputs from the trucks 134 surrounding the loading station 200 of FIG. 6A, which received the signal 146 emitted by the beacon 124. The table 208 of reported data may contain, for the same beacon 124, the truck device identifier 206, permitting to identify the truck 134 having received the beacon signal 146, the RSSI value 204 and the determined corresponding distance 210 from the beacon 124. In this particular embodiment, the distance 210 may have been calculated by the coordinating computer 138. Nevertheless, it will be understood that the distance 210 can be calculated by any alternate computer, such as the truck computer 140 for instance, and directly communicated to the coordinating computer 138. It is understood that in alternate embodiments, the distance 210 (in meters) may be omitted altogether, and the RSSI value 204 may be used “as is” to determine relative proximity of the truck devices 136 to the beacon 124 without departing from the present disclosure. The information shown in the table 208 of reported data shown in FIG. 6B is exemplary and meant only to show the type of information which may be present in the database of a coordinating computer. In alternate embodiment, the reported data may be presented in alternate forms, contain alternative information or may simply be omitted altogether without departing from the present disclosure.

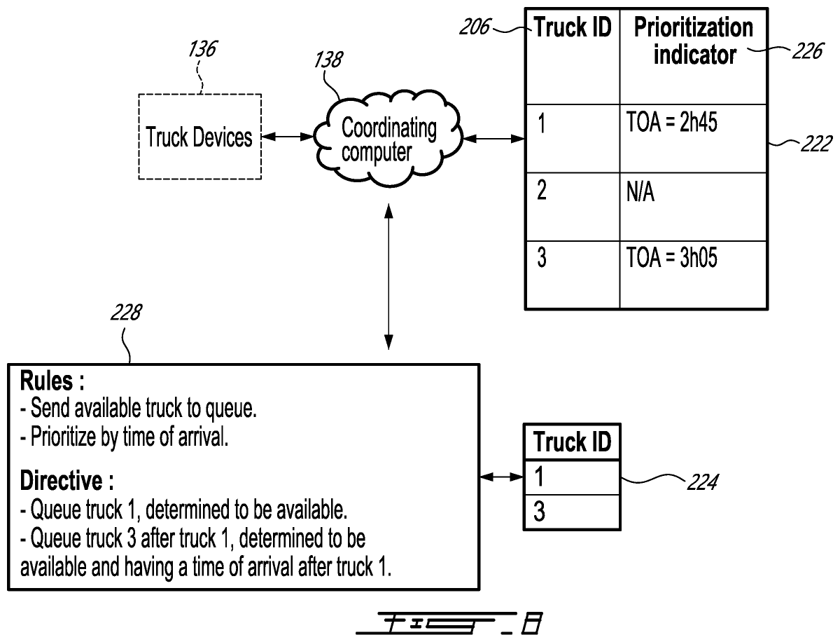

Attention is now brought to FIG. 7, showing another example embodiment of a truck 134, in this case concrete truck, equipped with a truck device 136 such as shown in FIG. 2. In this particular embodiment, a truck 134 in a batch plant site can receive a plurality of signals 146 from numerous beacons 124. For instance, a first beacon 212 may be placed at a slump stand station 214 and a second beacon 216 may be placed at a loading station 218. The truck 134, and corresponding truck device 136, may be located in the batch plant site and in the vicinity of both beacons 212, 216 so as to receive a signal 146 from both the beacon 212 of the slump stand 214 and the beacon 216 of the loading station 218. As is illustrated, the distance 213 between the truck 134 and the slump stand 214 is greater than the distance 215 between the truck 134 and the loading station 218. The truck device 136 can determine a received signal strength indicator value 204 for each one of the beacon signals 146, which may be representative of the distance of the truck 134 from each of the stations 214, 218. In this particular embodiment, the truck device 136 may communicate a plurality of inputs to the coordinating computer 138, including the beacon identifiers 220, their corresponding RSSI values 204 and the truck identifier (not shown) for instance.

It is understood that, in alternate embodiments, the amount of beacon signals 146 received may be scaled up without departing from the present disclosure. For instance, the truck device 136 may simultaneously receive more than 2 beacon signals 146, such as 3, 4, or 10 beacon signals 146.

Returning to FIG. 2, the coordination computer 138 can determine a truck task and queue order based on the inputs received from the truck devices 136, and can further be configured to transmit directive signals back to the truck devices 136. In this particular embodiment, the coordinating computer 138 can have access to a set of rules, which permit it to determine a queue order and determine directive information to be transmitted to the truck device 136. Example of different scenarios incorporating such rules will now be discussed below.

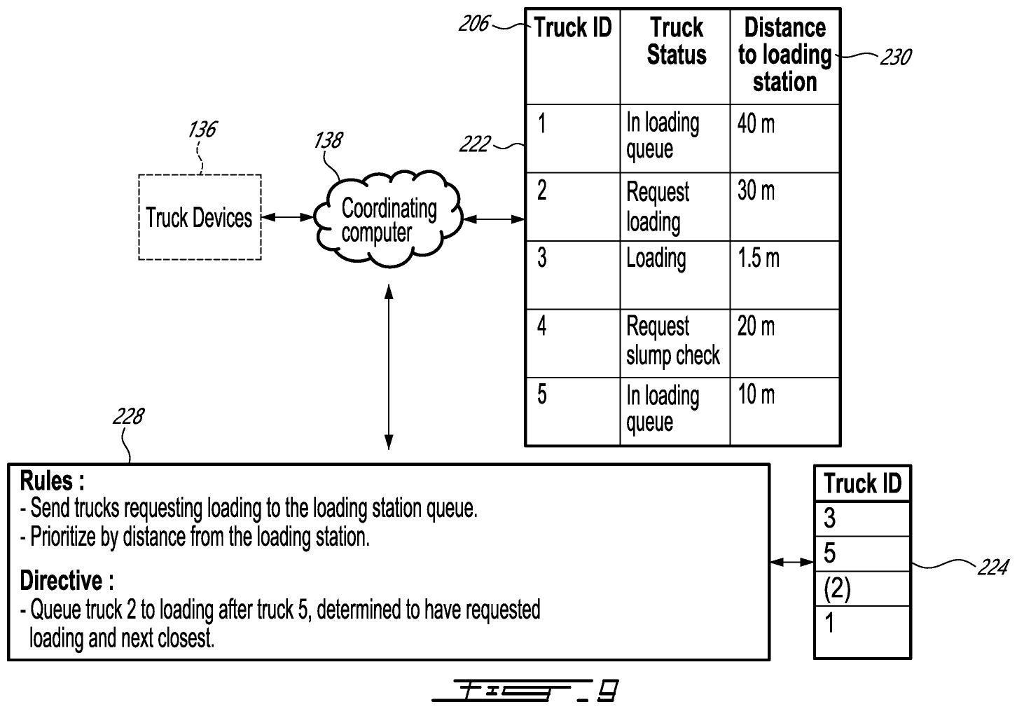

Attention is brought to FIG. 8, showing an example of a coordinating computer 138 which may be configured to determine a queue order. The coordinating computer 138 can receive inputs from the truck devices 136 and store the information in a status table 222. The coordination computer 138 can further store a queue 224, where trucks may be assigned a position in an order to complete a certain task. It will be understood that the expression “queue” as used herein is not to be interpreted in a limiting manner. It is rather used in a broad sense to generally refer to a sequence of trucks listed for an action.

In this particular example, the coordinating computer 138 may have received inputs from different truck devices 136 following the receipt of a signal from a beacon by said truck devices 136. The truck inputs may include a truck identifier 206 and a prioritization indicator 226. In this particular example, the prioritization indicator 226 may be a time of arrive (TOA) logged when a signal from a given beacon is received by the truck device 136, for instance. The coordination computer 138 can store the inputs received from the different trucks in the status table 222.

The coordinating computer 138 can use the information from the status table 222 to determine a queue order 224 based on rules. In this embodiment, the coordinating computer 138 can use the rules of sending available trucks to the queue and prioritizing the order based on the prioritization indicator, generally referred to a coordination directive 228 in the present application. Accordingly, the coordinating computer 138 can fill the queue 224 with the truck identifiers 206, having been optimized and ordered based on the rules stored in the coordinating computer 138, and further use the queue 224 to transmit directives back to truck devices 136. In this particular example, truck 1 is queued first as being available with the earlier time of arrival, followed by truck 3. As the truck devices 136 send additional inputs to the coordinating computer 138, the coordinating computer may update the status table 222 and, accordingly, update the queue 224. The changes to the queue 224 can then further be communicated to the truck devices 136.

It is noted that truck device 136 inputs sent to the coordinating computer 138 can be stored in the status table 222, even in a circumstance where such a truck is excluded by the rules and may not be store in the queue 224, such as is shown with the truck device identified as number 2 in the status table 222 of FIG. 8. This truck device 136 status may be labeled as unavailable or having a not applicable (N/A) status for instance, thus excluding it from the queue 224. Such a label may be used when a truck device 136 input includes additional information which may require it to be omitted from the queue 224, such as when the truck driver requires a break for instance, or when the truck must be classified in another separate queue, such as when truck driver determines the truck requires maintenance for instance.

Attention is now brought to FIG. 9, showing another example implementation of a coordinating computer 138 which can be configured to determine a queue order. As disclosed above, the coordinating computer 138 can receive a plurality of inputs from various truck devices 136, can store them in a status table 222 and determine a queue order based on rules. In this embodiment, the queue 224 is a loading station queue and the truck device 136 inputs received by the coordinating computer 138 may include a received signal strength value from the beacon placed at the loading station in question. The RSSI value can be converted to a distance in meters and stored in the status table as a distance to the loading station 230. It is understood that in alternate embodiments, the RSSI value may be used as is without conversion to a distance in meters.

In this particular example and at this point in time, numerous truck devices 136 may have previously transmitted inputs to the coordinating computer 138, the information may have been previously stored in the status table 222 and a previous queue order may have been identified in the loading station queue 224. Such is the case of the trucks identified by the numbers 3, 5 and 1 in the status table 222 of FIG. 9. When the coordinating computer receives an input identifying a new truck status or an updated truck status in the status table 222, it can update the queue based on the rules of the coordination directive 228 associated to said queue 224. In this particular example, inputs can be received from the truck device identified by the number 2 and stored in the status table 222. The coordinating computer may assign it a “Request loading” truck status based on the inputs received. The coordinating computer 138 can then use the rules of sending trucks requesting loading to the loading station queue 224 and prioritizing the queue 224 by distance from the loading station to determine the new loading station queue order. In this example, the truck number 2 can be queued in the loading queue after truck number 5, but before truck number 1 as shown in parenthesis, as it is determined to have requested loading, is further from the loading station beacon than trucks 3 and 5, but is closer than truck 1. At this stage, the coordinating computer 138 can transmit the directives to the truck device 136, informing the truck driver of their next task and position in the queue 224 for instance, and updating the truck status of truck number 2 to “In loading queue” in the status table 222.

It will be understood that the coordinating computer 138 may further coordinate other parallel queues using the same rules without departing from the present disclosure. For instance, the coordinating computer 138 can use the rules of sending trucks requesting slump check to the slump stand queue and prioritizing the queue by distance from the slump stand to determine the slump queue order.

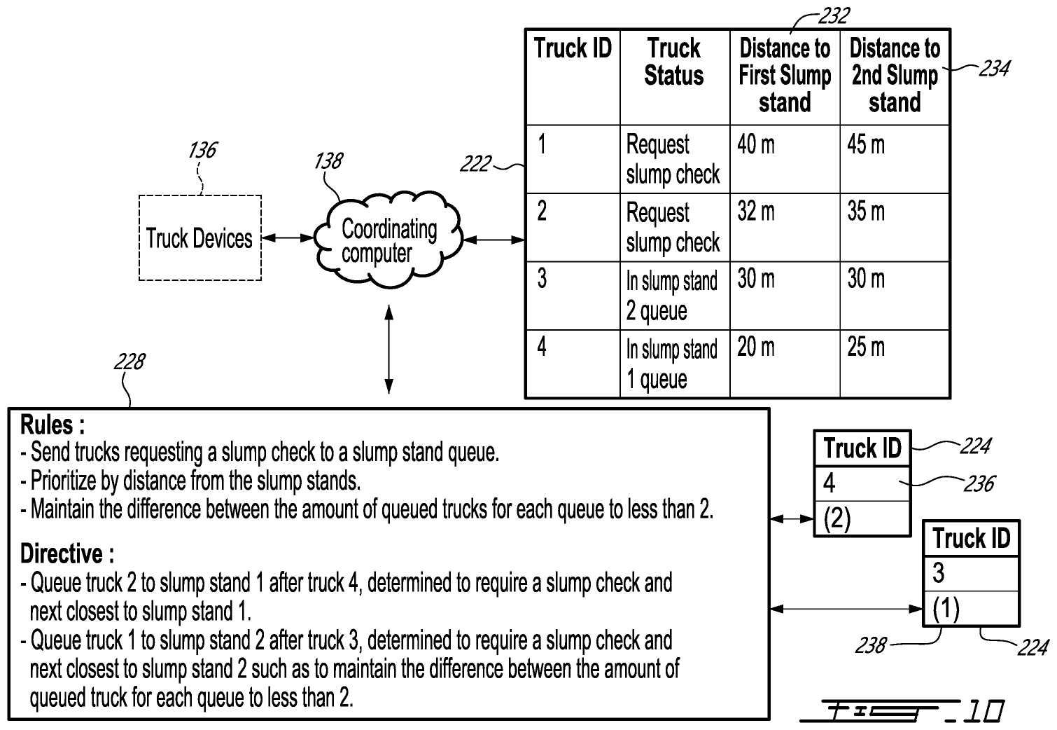

Attention is now brought to FIG. 10, showing yet another example implementation of a coordinating computer 138 which can be configured to determine a queue order. In this embodiment, there are a plurality of queues 224 for the same type of station, such as a slump stand for instance, resulting in a first queue 236 for a first slump stand (alternatively referred to as “slump stand 1”) and a second queue 238 for a second slump stand (alternatively referred to as “slump stand 2”). The truck device 136 inputs received by the coordinating computer may include a received signal strength value from the beacon at the each of the slump stands. The RSSI signal can be converted to a distance in meters and stored in the status table as a distance from a first slump stand 232 and a distance from the second slump stand 234. As with the previous embodiment, numerous truck devices 136 may have previously transmitted inputs to the coordinating computer 138 and may have already been identified in the queues 236, 238, such is the case of the trucks 4 and 3 in FIG. 10.

In this particular example, the rules used in the coordination directive 228 in the previous embodiment best seen in FIG. 9 can be combined to the rule of maintaining the difference between the amount of queued trucks for each queue to less than 2. Thus, should the coordinating computer 138 receive inputs from trucks 1 and 2, and identify their status as “Request slump check” as seen in the status table 222 of FIG. 10, the coordinating computer 138 may use the rules to queue truck 2 after truck 4 in the first slump stand queue 236 (shown in parenthesis), determined to be the next closest to slump stand 1. In a similar fashion, the coordinating computer 138 can queue truck 1 after truck 3 (shown in parenthesis), the second slump stand queue 238, determined to be next closest truck requesting slump check to the second slump stand such as to maintain the difference between the amount of queued trucks for each queue 236, 238 to less than 2. At this stage, the coordinating computer 138 can transmit the directives to the required truck devices 136, informing the truck drivers of their next task and position in their respective queue 224 for instance, and update the truck status of truck 2 to “In first slump stand 1 queue” and truck 1 to “In slump stand 2 queue” in the status table 222.

It will be understood that the use of a plurality of queues for the same type of station can be scaled such that there are more than two queues, such as 3, 5 or 10 queues for instance, without departing from the present disclosure.

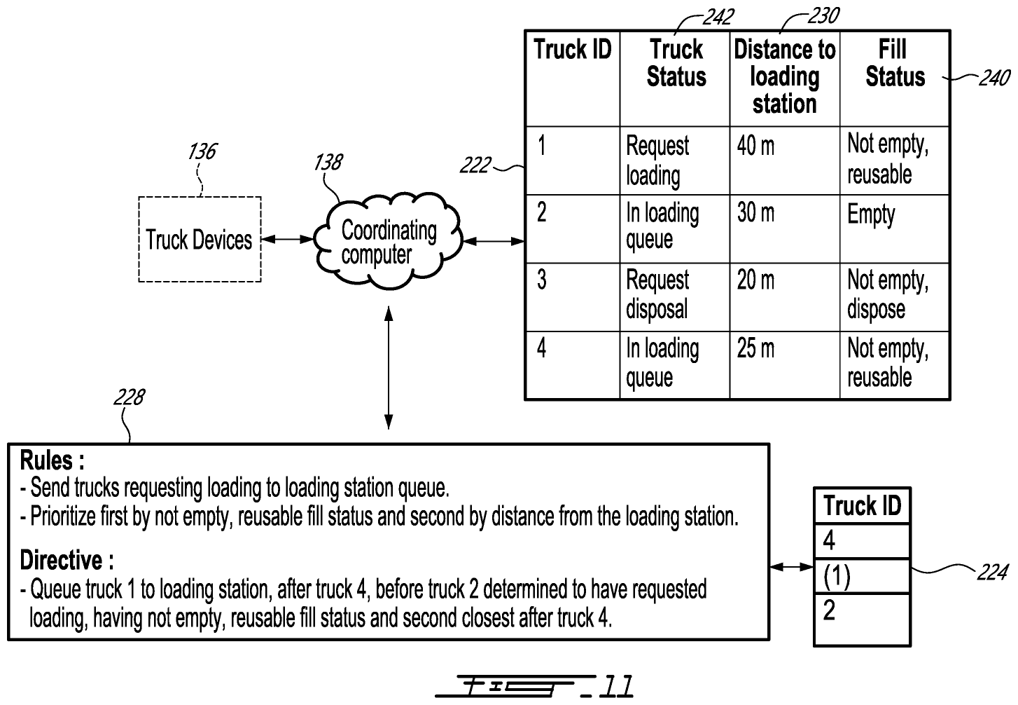

Attention is now brought to FIG. 11, showing yet another example implementation of a coordinating computer 138 which can be configured to determine a queue order. In this embodiment, the queue 222 is a loading station queue and the truck device inputs received by the coordinating computer 138 can include a received signal strength value from the beacon at the loading station, which can be converted to a distance in meters and stored in the status table 222 as a distance to the loading station value 230. The status table further receiving a fill status 240, representative of the status of the mixing drum of the truck. As with the previous embodiments, numerous truck devices 136 may have previously transmitted inputs to the coordinating computer 138 and may are already identified in the queue 224, such is the case of the trucks numbered 4 and 2 in FIG. 11.

In this particular example, the coordinating computer 138 identifies the truck status 242 based on both the loading station distance and the fill status. For instance, should the inputs received by the coordinating computer indicate that a truck mixing drum contains material to be disposed of, such as by having a “Not empty, dispose” fill status 240 as is the case with truck 3 found in the status stable 222 of in FIG. 11, the coordinating computer 138 may assign a truck status identifying the required disposal, such as to exclude it from being assigned in the loading station queue 224. Accordingly, one will understand that the coordinating computer 138 can comprise a parallel disposal or reclaimer station queue (not shown), for which truck 3 may be assigned a position based on rules to that effect.

Still referring to FIG. 11, in this embodiment, priority in the queue order may be given to a truck requesting loading and further having a “Not empty, reuse” fill status indicating that the mixing drum is not empty and contains material that may be reused, such as by filling at the loading station for instance. Accordingly, the coordinating computer 138 can use the rules of sending trucks requesting loading to a loading station queue and prioritizing first by “not empty, reusable” fill status 240 and second by distance to the loading station 230, in order to determine the queue order. For instance, should the coordinating computer receive inputs from truck 1 such as to identify it with a request loading truck status 242, while further having a “not empty, reusable” fill status 240, as shown in the status table 222 of FIG. 11, the coordinating computer 138 may queue truck 1 after truck 4 and before truck 2 (shown in parenthesis), as it is determined to be the next closest truck to the loading station beacon having a “not empty, reusable” fill status. At this stage, the coordinating computer can transmit the directives to the required truck devices, informing the truck drivers of their next task and position in the queue for instance, and update the truck status of truck 1 to “In loading queue” in the status table.

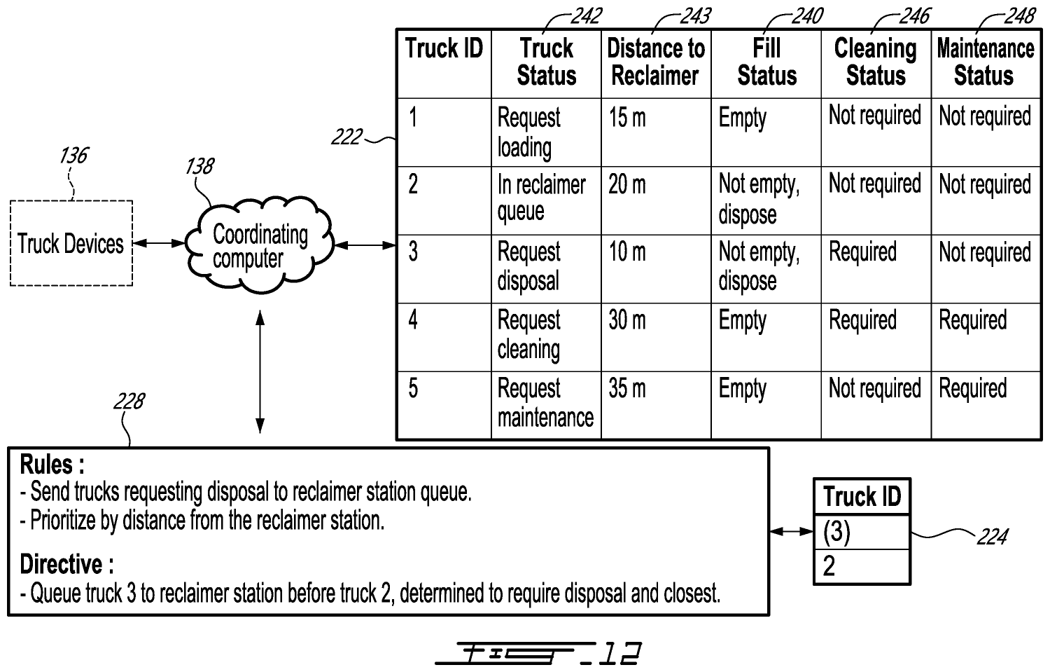

Referring now to FIG. 12, showing yet another example implementation of a coordinating computer 138 which can be configured to determine a queue order. In this embodiment, the queue 224 is a reclaimer station queue and the truck device inputs received by the coordinating computer can include a received signal strength value from the beacon at the reclaimer station, which can be converted to a distance in meters and stored in the status table 222 as a distance to reclaimer 243, a fill status 240, representative of the status of the mixing drum of the truck, a cleaning status 246, representative of the requirement to clean the mixing drum for instance, and a maintenance status 248, representative of the requirement to maintain the truck. In this example, the coordinating computer 138 identifies the truck status 242 based on the distance from the station of interest, in this case the distance to the reclaimer 243, the fill status 240, the cleaning status 246 and the maintenance status 248. The “request loading” truck status may only be given in conditions where the truck inputs indicate that the fill status 240 does not require disposal, that the truck does not require cleaning via the cleaning status 246 and that the truck does not require maintenance via the maintenance status 248. Should a truck input identify a requirement for disposal, a requirement for cleaning or a requirement for maintenance, a truck status identifying their corresponding need is given. Should a truck input identify a plurality of needs between disposal, cleaning and maintenance, the coordinating computer will give a truck status priority to the disposal requirement, followed by the cleaning requirement and further followed by the maintenance requirement.

As with the previous embodiments, numerous truck devices 136 may have previously transmitted inputs to the coordinating computer 138 and may already be identified in the queue, such is the case of the truck 2 in the reclaimer station queue 224 of FIG. 12. In this example, should a truck be identified with a requesting disposal truck status, such as is the case for truck 3 in the status table 222 of FIG. 12, the coordinating computer 138 can use the rules of sending trucks requesting disposal to the reclaimer station queue 224 and prioritizing by distance from the reclaimer station, in order to determine the queue order. Accordingly, the coordinating computer 138 may queue truck 3 before truck 2 (as shown in parenthesis), as it is determined to require disposal and is closest to the reclaimer station. At this stage, the coordinating computer can transmit the directives to the required truck devices, informing the truck drivers of their next task and position in the queue for instance, and update the truck status 242 of truck number 3 to “In reclaimer station queue” in the status table.

It will be understood that when truck 3 disposes of the material from the mixing drum, the truck device can further transmit inputs updating the fill status 240 of the truck to “Empty”, ultimately changing the truck status to “Request cleaning”, at which point the coordinating computer 138 may consider the truck for the corresponding station queue.

It will be understood that in the embodiments shown in FIGS. 8-12, only the required information to understand the logic behind queue order determination steps were shown. It will be understood that the coordinating computer 138 can determine a plurality of queues 224 simultaneously, such as loading station queues, slum stand queues, reclaimer station queues, cleaning stations queues and/or maintenance station queues, to name a few examples. Similarly, it will be understood that the status table 222 can contain the received signal strength indicator value, or a corresponding distance, for each one of the beacons for which the truck device may have received a signal. For instance, while the status table 222 of the coordinating computer 138 in FIG. 12 only shows the reclaimer station distance, it can be understood that the status table may further contain loading station distance values, cleaning station distance values and/or a maintenance station distance values.

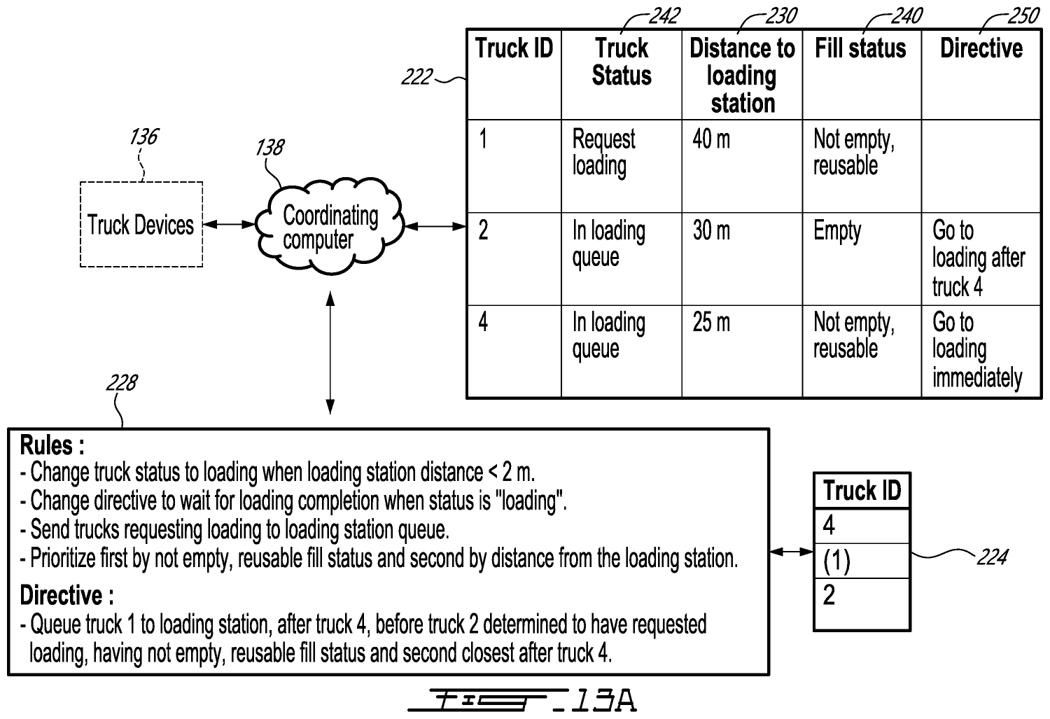

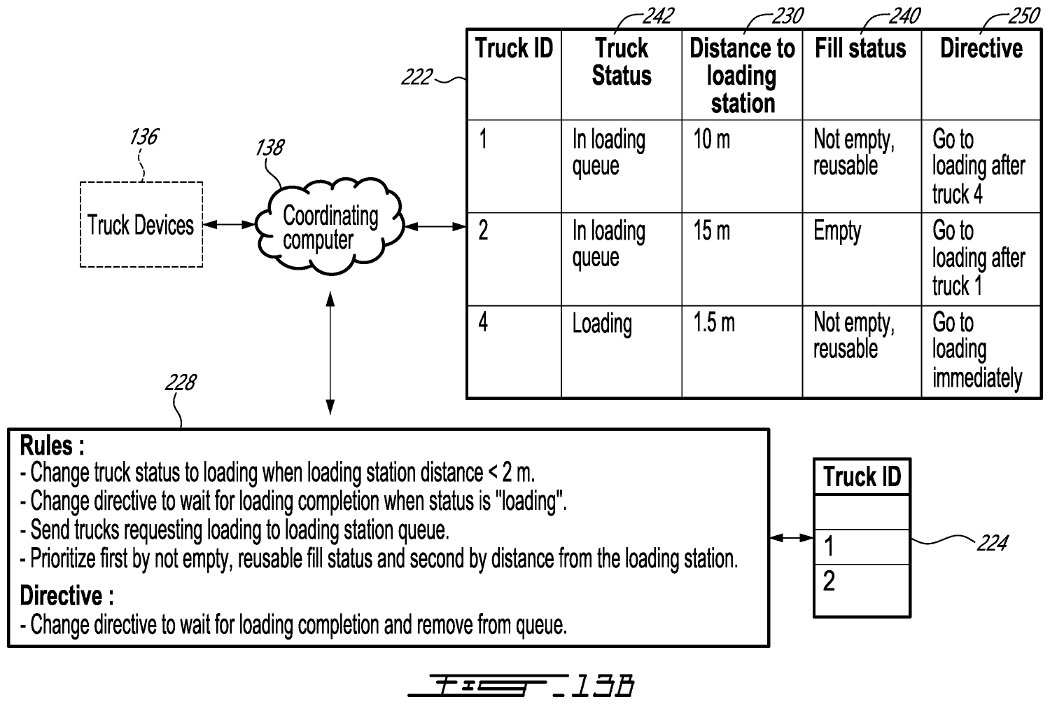

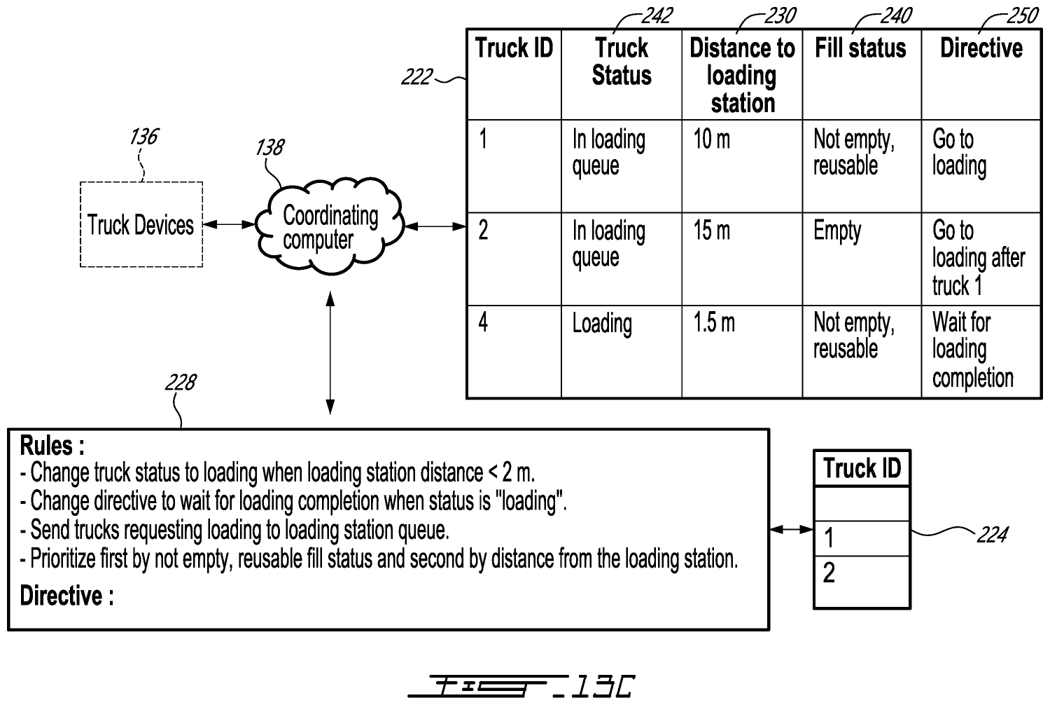

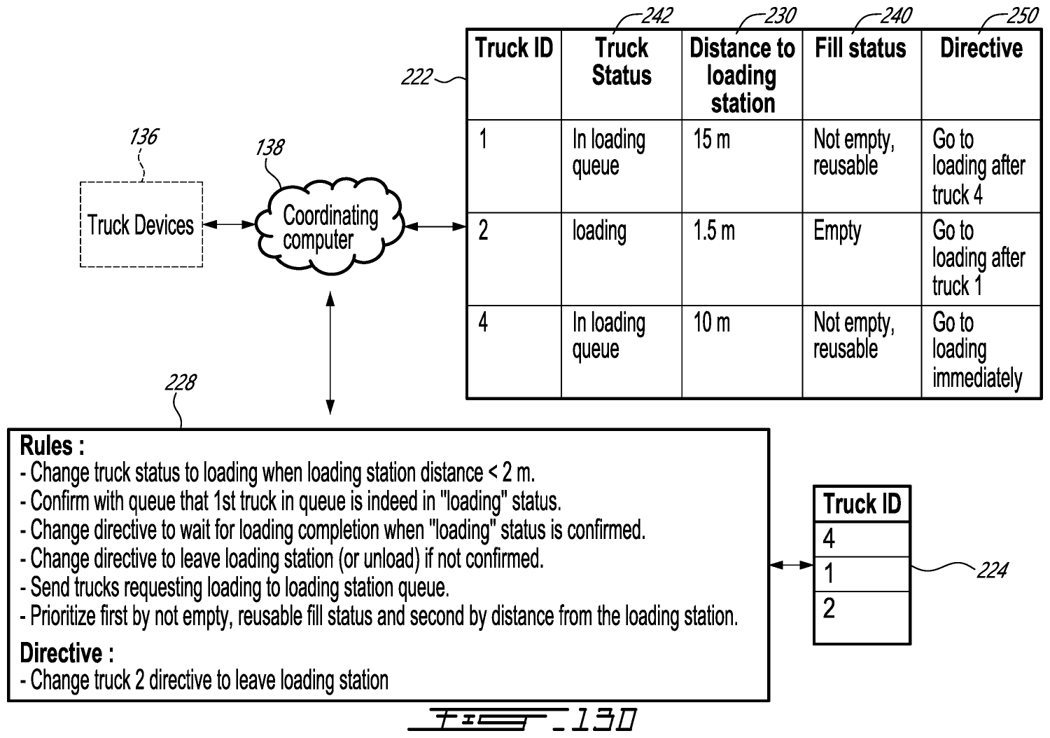

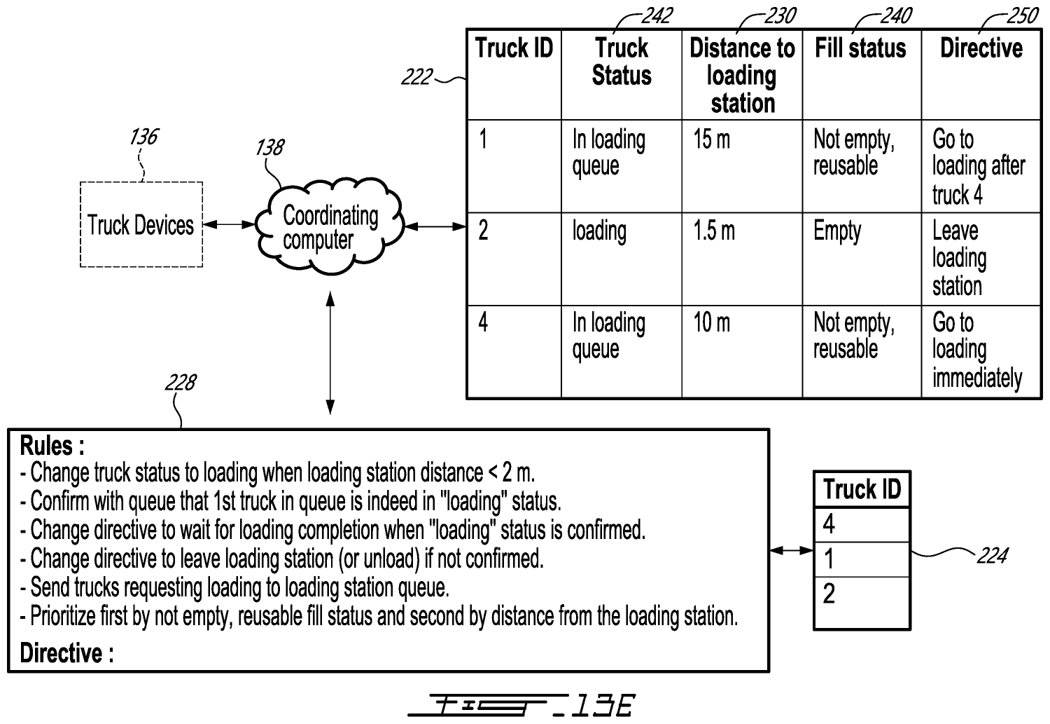

Attention is now brought to FIGS. 13A to 13C showing another example implementation of a coordinating computer 138 which can be configured to determine a queue order. This example is similar to the example seen in FIG. 11 and explained above, but will further be discussed to exemplify the progression of the directives 250 that may be given to each one of the trucks and the corresponding progression of the queue 224 in time. As with FIG. 11, the queue 224 is a loading station queue and the truck device inputs received by the coordinating computer 138 can include a received signal strength value from the beacon at the loading station, converted and shown as a distance to the loading station 230 and a fill status 240. Some truck devices may have previously transmitted inputs to the coordinating computer 138 and may are already identified in the queue 224, such is the case of the trucks 4 and 2 in the queue 224 of FIG. 13A.

In this particular example, the coordinating computer 138 may use the same rules previously described for FIG. 11 in combination with the additional rules of changing the truck status to “loading” when the distance from the loading station is determined to be less than 2 m and changing the directive 250 sent to the truck by the coordinating computer 138 to “Wait for loading completion” when the truck status is determined to be loading. For instance, should the coordinating computer 138 receive inputs from truck 1 such as to identify it with a “request loading” truck status 242, such as is the case in FIG. 13A, the coordinating computer may use the rules to queue truck 1 after truck 4 and before truck 2 (shown in parenthesis) in the queue 224.

At this stage, the coordinating computer 138 can transmit the directives 250 to the required truck devices, informing the truck drivers of their respective actions. This is perhaps best seen in FIG. 13B, showing a point in time after FIG. 13A, where the directive 250 associated to truck 2 can be seen to have changed from “Go to loading after truck 4” (see FIG. 13A) to “Go to loading after truck 1” in the status table 222.

Still referring to FIG. 13B, truck 4, having been previously identified as first in the queue 224, may have had the time to approach the loading station and transmit inputs to the coordinating computer 138 indicating a loading station distance of 1.5 m, for instance. As can be seen in the status table, the coordinating computer can associate a “loading” truck status to truck 4 based on the supplied inputs identifying its proximity. Following the rules identified above, the coordinating computer 138 may further send the directive 250 of “wait for loading completion” to the truck device and thus remove the truck from the loading station queue 224.

At this stage, it can be understood that the coordinating computer 138 may transmit update directives to the other trucks based on the progression or changes to the queue 224. This is perhaps best seen in FIG. 13C, which shows a point in time after FIG. 13A and 13B. As can be seen, the directive 250 of truck 4 can be updated to “wait for loading completion”, while a “go to loading” directive may be transmitted to the truck 1, as the truck 4 may no longer form part of the queue 224.

As can be understood, such a progression of the directives 250 and of the queue 224 can be logged/registered in the database of the coordinating computer 138 for instance, and can be used for traceability purposes. For instance, the load of a truck can be confirmed based on the combination on the received signals of the beacons by the trucks and the time of loading at the loading station, perhaps by matching truck information with information supplied by the loading station, for instance. This may permit to determine with a greater certainty that a specific load is in the correct truck, for instance. An exemplary method will further be discussed below.

Attention is now brought to FIG. 13D and 13E, showing another example implementation of a coordinating computer 138 which can be configured to determine a queue order. These figures also show a progression of the directives 250 and the queue 224 over time, as with FIGS. 13A-13C, but in an alternate scenario. As with other embodiments above, and as perhaps best seen in FIG. 13D, some truck devices 136 may have previously transmitted inputs to the coordinating computer and may are already identified in the queues, such is the case of all the trucks shown in FIG. 13D, where the loading station queue 224 has identified a queue order with truck 4 first, followed by truck 1 and further followed by truck 2. In this example, while truck 2 had received the directive to go to loading after truck 1, truck 2 may have directed itself to the loading station and be in a loading position, where the truck device may have reported inputs indicating a loading station distance of 1.5 m for instance and been given a “loading” truck status 242.

In this particular example, the coordinating computer 138 may use the same rules identified in FIGS. 13A-13C above and can further include the rules of confirming with the queue 224 that the first truck in the queue 224 is the one with a loading truck status, changing the directive 250 to “wait for loading completion” if the above query is confirmed, and changing the directive 250 to “leave loading station” if the above query is not confirmed.

Accordingly, the coordinating computer 138, following the outlined rules, may transmit a change in directive 250 to truck 2 to inform it to leave the loading station, as best seen in FIG. 13E. It will be understood that truck 2 may subsequently receive directives 250 informing the truck driver of its position in the loading station queue 224, for instance. It is understood that in an alternate embodiments, the truck may have received an unwanted load, and, accordingly, the coordinating computer 138 may further remove the truck from the loading station queue and queue it in a reclaimer or unloading queue, as exemplified in previous embodiments above.

It is understood that the scenario identified above with relation to FIGS. 13D and 13E may be applied to other stations, such as the reclaimer station and the slump stand station, for instance. It is further understood that in alternate embodiments, other inputs may be included and considered in the status table. In yet other embodiments, the distance from the station may be omitted from consideration without departing from the present disclosure, such as by determining a truck has arrived at a station when a beacon signal is detected by the truck device, for instance.

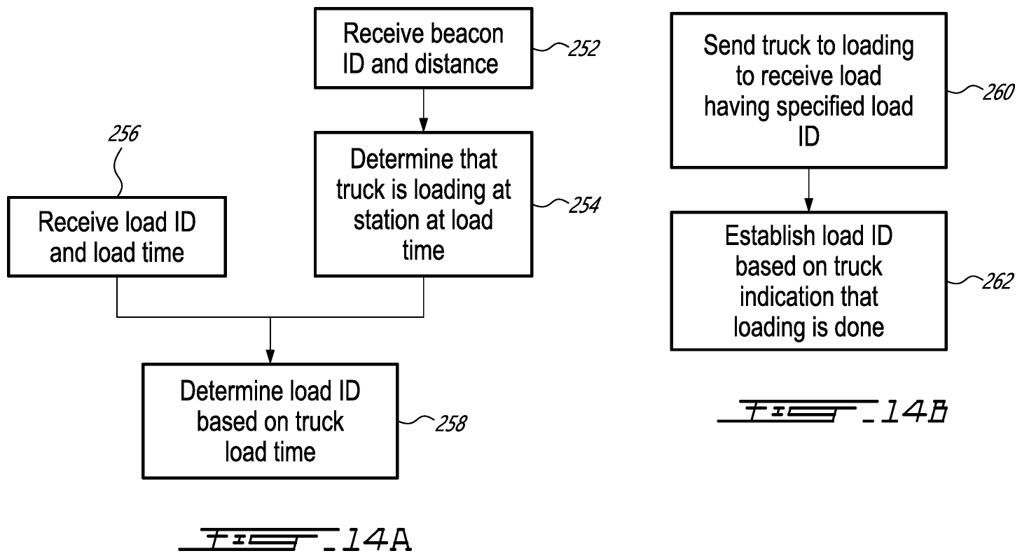

Attention is now brought to FIG. 14A, showing a flow chart of an example method of confirming that the correct truck is undergoing, or has undergone, an activity based on the beacon signal. In this example, the truck device inputs received by the coordinating computer, as described in the present disclosure, are recorded and permit to determine when a truck computer has received a beacon signal. As explained above, the inputs received by the coordinating computer may include the beacon identifier, the truck identifier as well as a received signal strength indicator value, which may be correlated to a distance. Such truck device inputs can permit to determine when the truck is loading at the loading station and further identify at what time such action may have taken place. Steps 252 shows the receiving of the information, such as the beacon ID and the distance in this example, while step 254 is the determination that the truck is loading at the station at a load time.

On the other hand, the coordinating computer may further be capable of receiving and consolidating information from the loading station itself. As described above in relation to FIG. 2, the coordinating computer is capable of interfacing with a plurality of external systems, including a batch system incorporating the loading station for instance. In this particular example, the coordinating computer may further receive inputs from the batch system and/or the loading station. The batch system inputs may be compiled in a database similar to the one used for the inputs from the truck devices, for instance, or may be compiled in a separate database, and may compile a load table, wherein information such as load identification numbers, load specifications, time of loading and other information may be logged. Returning to FIG. 14A, the information received from the loading station, such as its loading identifier and loading time shown at step 256, may be determined to correspond to a truck based on load time and may permit referencing both data sets as being linked to one another. Step 258 shows such referencing, where the load ID is identified based on load time.

Attention is now brought to FIG. 14B, showing a flow chart of another example method of confirming that the correct truck is undergoing an activity based on a beacon signal. In this particular example, the truck may be sent to the loading station in order to receive a load having a specified load identifier, as shown in step 260. The established load, having a corresponding load identifier, may be determined as having been loaded in the specified truck when the truck inputs sent to the coordinating computer permit to identify that the loading has been completed, shown in step 262.

It will be understood that the methods explained above may be applied to circumstances other than the loading of a truck without departing from the present disclose.

As can be understood, the examples described above and illustrated are intended to be exemplary only. Indeed, although examples about concrete plants are presented above, it will be understood that the coordinating system can be equally applied to direct trucks in another sector of the heavy building industry, such as, cement, admix, aggregates, pre-cast, etc. The scope is indicated by the appended claims.

What is claimed is:

1. A computer-implemented method of coordinating the actions of a plurality of trucks using at least one beacon, the method comprising:
the at least one beacon sending a first signal including a first signal beacon identifier to a first truck device of a first one of the trucks;
the at least one beacon sending a second signal including a second signal beacon identifier to a second truck device of a second one of the trucks;
a coordinating computer
receiving a first input from the first truck device, the first input including at least the first signal beacon identifier and a first truck identifier;
receiving a second input from the second truck device, the second input including at least the second signal beacon identifier and a second truck identifier;
determining a queue order for the trucks based on the first input and the second input; and
transmitting directive signals to the trucks based on the queue order.

2. The method of claim 1, further comprising, after receiving the first input from the first truck device and the second input from the second truck device, storing in a database a status table based on the inputs received from the trucks.

3. The method of claim 2, further comprising, after receiving the first input from the first truck device and the second input from the second truck device, determining a truck status based on the inputs.

4. The method of claim 3, further comprising, before determining the queue order for the trucks, determining a queue associated to a station based on the truck status.

5. The method of claim 1, wherein the first input from the first truck device further includes a first signal receipt time and the second input from the second truck device further includes a second signal receipt time

6. The method of claim 5, further comprising, after receiving the first input from the first truck device and the second input from the second truck device, determining a time of arrival of the trucks to a location.

7. The method of claim 6, wherein the step of determining a queue order includes prioritizing based on the time of arrival.

8. The method of claim 1, wherein the first input from the first truck device further includes a first received signal strength indicator value from the at least one beacon, and the second input from the second truck device further includes a second received signal strength indicator value from the at least one beacon.

9. The method of claim 8, wherein the step of determining the queue order includes prioritizing based on received signal strength indicator values.

10. The method of claim 8, further comprising, after receiving the first input from the first truck device and the second input from the second truck device, determining a truck distance from the at least one beacon for each truck using the received signal strength indicator values.

11. The method of claim 10, wherein the step of determining the queue order includes prioritizing based on truck distance from the at least one beacon.

12. The method of claim 1, wherein the first input from the first truck device further includes a first fill status, and the second input from the second truck device further includes a second fill status.

13. The method of claim 12, wherein the step of determining the queue order includes giving precedence to the trucks having a fill status indicating the trucks contain a reusable load when determining the queue order of a loading station.

14. The method of claim 1, wherein the first input from the first truck device further includes a first cleaning status, and the second input from the second truck device further includes a second cleaning status.

15. The method of claim 1, wherein the first input from the first truck device further includes a first maintenance status, and the second input from the second truck device further includes a second maintenance status.

16. The method of claim 1, wherein the step of determining the queue order includes determining the queue order of a plurality of corresponding queues for stations serving the same purpose.

17. The method of claim 16, wherein the step of determining the queue order includes maintaining a amount of queued truck difference between each of the plurality of corresponding queues to less than 2.

18. The method of claim 17, wherein the directive signals to the trucks are representative of a position in the queue order.

19. A computer program product comprising a computer readable memory storing computer executable instructions thereon that, when executed by a computer, coordinates the actions of trucks by receiving a first input from a first truck device, the first input including at least a first signal beacon identifier and a first truck identifier, receiving a second input from a second truck device, the second input including at least a second signal beacon identifier and a second truck identifier, determining a queue order for the trucks based on the first input and the second input, and transmitting directive signals to the trucks based on the queue order.

20. A computer-implemented method of coordinating the actions of a plurality of trucks using at least one beacon via a queue including at least a first truck and a second truck, the queue being stored in a memory accessible to a coordinating computer, the method comprising:
the at least one beacon sending a first signal including a first signal beacon identifier to a first truck device of the first truck;
a coordinating computer
receiving a first input from the first truck device, the first input including at least the first signal beacon identifier and a first truck identifier,
determining whether the first truck is in a first position in the queue.

21. The computer implemented method of claim 20 wherein said determining yields that the first truck is not in a first position in the queue, further comprising transmitting a directive signal to the first truck directing the first truck away from the beacon sending the first signal beacon identifier.

22. The computer implemented method of claim 20 wherein said determining yields that the first truck is in a first position in the queue, the queue is a loading queue, further comprising confirming a load identification associated to the first truck based on the determination.
